(19) United States
(12) Patent Application Publication
(10) Pub. No.: US 2014/0128309 A1
(43) Pub. Date: May 8, 2014

(54) CONDITIONING COSMETIC CLEANING AGENT HAVING IMPROVED FOAMING PROPERTIES

(71) Applicant: Henkel AG & Co. KGaA, Duesseldorf (DE)

(72) Inventors: Bernhard Banowski, Duesseldorf (DE); Marcus Claas, Hilden (DE)

(73) Assignee: Henkel AG & Co. KGaA, Duesseldorf (DE)

(21) Appl. No.: 14/151,125

(22) Filed: Jan. 9, 2014

Related U.S. Application Data
(63) Continuation of application No. PCT/EP2012/063107, filed on Jul. 5, 2012.

(30) Foreign Application Priority Data
Jul. 11, 2011 (DE) 10 2011 078 952.9

(51) Int. Cl. C11D 3/20; C11D 1/94

(52) U.S. Cl. CPC C11D 3/2096; C11D 1/94
USPC 510/473

(57) ABSTRACT

Cosmetic cleaning agents include, in a suitable carrier, a) at least one alkyl sulfate salt and/or alkyl polyglycol ether sulfate salt, b) at least one amphoteric and/or zwitterionic surfactant according to one of the general formulae (I) or (II) as defined herein, c) at least one sorbitan acid ester and d) at least one non-ionic cellulose ether, with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

### FIELD OF THE INVENTION

The present invention generally relates to cosmetics and relates to cleaning agents containing a special surfactant mixture in a specific ratio, a sorbitan acid ester and a non-ionic cellulose ether.

### BACKGROUND OF THE INVENTION

Cosmetic cleaning agents for the skin and/or hair, such as liquid soaps, shampoos, shower washes, foam baths and shower and washing gels, must in addition to their cleaning ability also be well tolerated by the skin and/or mucosa and must not damage the skin barrier even in frequent use.

Modern cleaning agents therefore often contain additional conditioning components such as cationic polymers, moisturizing components and/or emollients so as to cause as little disruption as possible to the natural balance of the moisture content of the skin (scalp).

In addition to incorporating additional conditioning components, it is desirable to combine them with particularly gentle surfactant mixtures.

The laid-open patent application WO 2007/006402 discloses gentle cleaning agents with improved foam and foaming properties, which contain a combination of
a) anionic sulfuric acid esters,
b) amphoteric surfactants, and
c) >1.2 wt. % of ethoxylated glycerol fatty acid esters having 3 to 12 ethylene oxide units, wherein the total surfactant content (a), b), c) and optionally further surfactants) is <16 wt. %.

The compositions are gentle. However, it was observed that the foam stability of the agents was not always satisfactory.

Patent application EP 1422288 discloses liquid soaps having improved foam properties, containing a combination of a maximum of 10 wt. % of anionic and amphoteric surfactants, alkali soaps and non-ionic cellulose ethers.

The liquid soaps yield a rich, very rapidly forming creamy foam, which rinses easily off the skin again. However, the amount of foam formed was not satisfactory.

There is therefore still a need for gentle cosmetic cleaning agents having an excellent cleaning action, good foaming ability and good foam properties.

The object of the present invention was to produce particularly gentle cosmetic cleaning agents having very good conditioning performance and skin compatibility.

The cleaning agents should moreover have outstanding foam properties.

The foam should be stable and should be capable of being readily distributed over the skin. It should also be capable of being rinsed off the skin again easily and leave the skin feeling relaxed.

Furthermore, other desirable features and characteristics of the present invention will become apparent from the subsequent detailed description of the invention and the appended claims, taken in conjunction with the accompanying drawings and this background of the invention

### BRIEF SUMMARY OF THE INVENTION

A cosmetic cleaning agent, containing in a suitable carrier: at least one alkyl sulfate salt and/or alkyl polyglycol ether sulfate salt; at least one amphoteric and/or zwitterionic surfactant according to one of the general formulae (I) or (II)

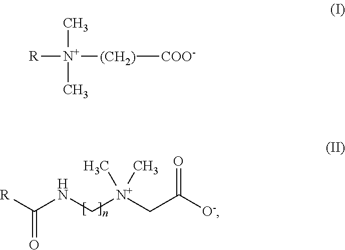

in which the residue R in each case denotes a straight-chain or branched, saturated or mono- or polyunsaturated alkyl or alkenyl residue having 8 to 24 carbon atoms and n denotes a number from 1 to 6; at least one sorbitan acid ester; and at least one non-ionic cellulose ether, with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention provides a cosmetic cleaning agent containing in a suitable carrier
a) at least one alkyl sulfate salt and/or alkyl polyglycol ether sulfate salt,
b) at least one amphoteric and/or zwitterionic surfactant according to one of the general formulae (I) or (II)

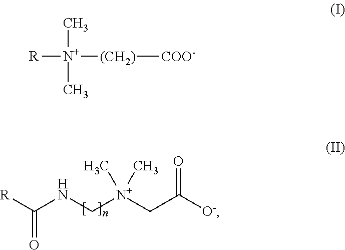

in which the residue R in each case denotes a straight-chain or branched, saturated or mono- or polyunsaturated alkyl or alkenyl residue having 8 to 24 carbon atoms and n denotes a number from 1 to 6,
c) at least one sorbitan acid ester and
d) at least one non-ionic cellulose ether,
with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

A suitable carrier is understood to be preferably an aqueous or aqueous-alcoholic carrier.

The cosmetic carrier preferably contains at least 50 wt. %, more preferably at least 60 wt. % and particularly preferably at least 70 wt. % water.

The cosmetic carrier can moreover contain 0.01 to 40 wt. %, preferably 0.05 to 35 wt. % and in particular 0.1 to 30 wt. % of at least one alcohol, which can be selected from ethanol, ethyl diglycol, 1-propanol, 2-propanol, isopropanol, 1,2-propylene glycol, glycerol, diglycerol, triglycerol, 1-butanol, 2-butanol, 1,2-butanediol, 1,3-butanediol, 1-pentanol, 2-pentanol, 1,2-pentanediol, 1,5-pentanediol, 1-hexanol, 2-hexanol, 1,2-hexanediol, 1,6-hexanediol, polyethylene glycols, sorbitol, sorbitan, benzyl alcohol, phenoxyethanol or mixtures of said alcohols.

The water-soluble alcohols are preferred.

Ethanol, ethyl diglycol, 1-propanol, 2-propanol, isopropanol, 1,2-propylene glycol, glycerol, benzyl alcohol and/or phenoxyethanol and mixtures of said alcohols are preferred in particular.

In order to achieve optimum gentleness and conditioning qualities, preferred cleaning agent according to the invention preferably have a weight ratio of the alkyl sulfate salt(s) and/or alkyl polyglycol ether sulfate salt(s) a) to the amphoteric or zwitterionic surfactant(s) of formula (I) or (II) in the range from 1:0.70 to 1:1.25 and particularly preferably in the range from 1:0.75 to 1:1.

Suitable alkyl sulfate salts and/or alkyl polyglycol ether sulfate salts a) for use in the cleaning agents according to the invention preferably correspond to the formula R—O(CH₂—CH₂O)ₓ—OSO₃⁻X⁺, in which R preferably denotes a linear or branched, saturated or unsaturated alkyl group having 8 to 30 C atoms, x denotes 0 or a number from 1 to 12 and X denotes an alkali, alkaline-earth, ammonium or alkanolamine ion.

Straight-chain or branched alkyl ether sulfates containing an alkyl residue having 8 to 18 and in particular 10 to 16 C atoms along with 1 to 6 and in particular 2 to 4 ethylene oxide units are particularly preferred because of their very good foaming properties and gentleness.

The sodium, magnesium and/or triethanolamine salts of linear or branched lauryl, tridecyl and/or myristyl sulfates having an average degree of ethoxylation of 2 to 4 are preferred in particular.

The alkyl sulfate salt(s) and/or alkyl polyglycol ether sulfate salt(s) a) is (are) preferably used in the cleaning agents according to the invention in amounts from 0.1 to 20 wt. %, more preferably from 0.5 to 15 wt. %, particularly preferably from 1 to 10 wt. % and in particular from 4 to 8.5 wt. %, the stated amounts relating to the total weight of the cleaning agent.

Suitable amphoteric/zwitterionic surfactants b) for use in the cleaning agents according to the invention correspond to one of the following formulae (I) or (II), in which the residue R in each case denotes a straight-chain or branched, saturated or mono- or polyunsaturated alkyl or alkenyl residue having 8 to 24 carbon atoms and n denotes a number from 1 to 6,

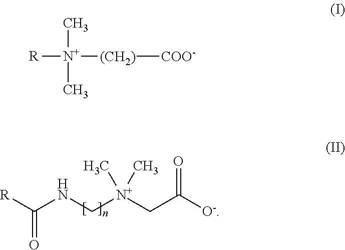

Preferred amphoteric and/or zwitterionic surfactants of one of the aforementioned formulae (I) or (II) mostly contain as the residue R a straight-chain or branched, saturated or mono- or polyunsaturated alkyl residue having 8 to 20, more preferably 8 to 16 and in particular 8 to 12 C atoms. In surfactants of formula (II) n preferably denotes the numbers 1, 2 or 3.

More preferred amphoteric/zwitterionic surfactants are C₈-C₁₂ alkyl and/or C₈-C₁₂ alkylamido (C₁-C₄) alkyl betaines of one of the aforementioned formulae (I) or (II).

The particularly preferred amphoteric/zwitterionic surfactants include the surfactants known under the INCI names Coco Betaine, Lauryl Betaine, Myristyl Betaine, Lauramidopropyl Betaine and/or Cocamidopropyl Betaine.

An amphoteric surfactant that is known under the INCI name Cocamidopropyl Betaine and is commercially available from a number of suppliers is preferred in particular.

The amphoteric/zwitterionic surfactant(s) according to one of the aforementioned formulae (I) or (II) is (are) preferably used in the cleaning agents according to the invention in amounts from 0.1 to 20 wt. %, more preferably from 0.5 to 15 wt. %, particularly preferably from 1 to 10 wt. % and in particular from 3 to 8 wt. %, the stated amounts relating to the total weight of the cleaning agent.

In order to achieve an optimum performance profile of the surfactant mixture (optimum foam properties and gentleness), it is preferable for the sum of all surfactants a) and b) in the cleaning compositions according to the invention to be a maximum of 15 wt. %, more preferably a maximum of 14.5 wt. % and in particular a maximum of 14 wt. %, the stated amount relating to the total weight of the cleaning composition.

The foam forming and the foam properties of the surfactant mixture can be significantly improved by the addition of a suitable sorbitan acid ester and of a suitable non-ionic cellulose ether to the aforementioned surfactant mixture.

The incorporation of conditioning components into the cleaning agents according to the invention is also possible without having a negative impact on the foam forming and the foam properties of the cleaning agents according to the invention.

Suitable conditioning components are described in more detail further on in the application.

Suitable sorbitan acid esters c) for use in the cleaning agents according to the invention are understood to be preferably esters of sorbitan with straight-chain or branched, saturated or unsaturated carboxylic acids having 4 to 16, preferably 5 to 12 and in particular 6 to 10 carbon atoms in the molecule.

Sorbitans are derived from the sugar alcohol sorbitol, which forms cyclic internal ethers while releasing water. Sorbitans are usually a mixture of products consisting predominantly of ethers of the following formulae (III) to (V):

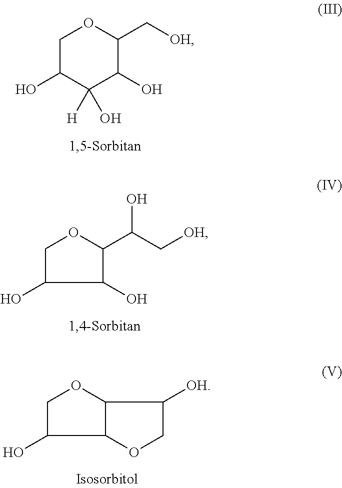 [SMILES: OCC1OCC(O)C(O)C1O ; OCC(O)C1OCC(O)C1O ; OC1COC2C(O)COC12]

Sorbitans also contain subordinate amounts of further condensation products and sorbitol.

Sorbitan esters are thus understood to be preferably mixtures of the aforementioned polyol mixtures with the aforementioned carboxylic acids, wherein it is moreover preferable for 1 mol of the polyol mixture to be esterified with 1 to 3 mol of carboxylic acid.

Particularly preferred cleaning agents according to the invention contain sorbitan esters c) as described above, which are formed by esterification of sorbitan with hexanoic acid, heptanoic acid, octanoic acid, nonanoic acid and/or decanoic acid.

Sorbitan esters formed from sorbitan and octanoic acid are particularly preferred.

Particularly preferred cleaning agents moreover contain aforementioned sorbitan carboxylates, which preferably have a hydroxyl value of over 350, more preferably over 400 and particularly preferably over 450.

The hydroxyl value can be determined by the conventional determination methods as known from the prior art, for example in accordance with DGF C-V 17a (53), Ph. Eur. 2.5.3 Method A, and DIN 53240.

Cleaning agents that are preferred in particular contain at least one sorbitan acid ester c), which preferably corresponds to an ester c) which is known under the INCI name Sorbitan Sesquicaprylate and is commercially available for example under the name Antil Soft® SC from Evonik.

The sorbitan acid ester(s) c) is (are) preferably used in the cleaning agents according to the invention in amounts from 0.01 to 5 wt. %, more preferably from 0.025 to 4 wt. %, particularly preferably from 0.05 to 3 wt. % and in particular from 0.1 to 2 wt. %, the stated amounts relating to the total weight of the cleaning agent.

Suitable non-ionic cellulose ethers d) for use in the cleaning agents according to the invention are derivatives of cellulose, in which the free hydroxyl groups have been replaced in part by alkoxy and/or hydroxyalkoxy residues.

Alkoxy residues are understood to be preferably C₁-C₄ alkoxy residues, and hydroxyalkoxy residues are understood to be preferably hydroxy C₁-C₄ alkoxy residues.

Examples of preferred non-ionic cellulose ethers d) are carboxymethylcellulose, methylcellulose, ethylcellulose, propylcellulose, hydroxymethyl cellulose, hydroxyethyl cellulose, hydroxypropyl cellulose, hydroxybutyl cellulose, hydroxyethyl methylcellulose, hydroxyethyl ethylcellulose, hydroxypropyl methylcellulose and hydroxybutyl methylcellulose.

It is possible in principle to add both simple cellulose ethers and mixed ethers (containing two or more different substituents) to the cleaning agents according to the invention.

Preferred cleaning agents contain mixed ethers containing both hydroxyalkoxy and alkoxy groups.

Particularly preferred cleaning agents contain at least one mixed hydroxyalkyl alkyl cellulose ether (mixed ether), the alkyl or hydroxyalkyl residues of which preferably contain 1 to 4 carbon atoms, as the non-ionic cellulose ether d).

Cleaning agents that are preferred in particular contain at least one non-ionic cellulose ether d) which preferably corresponds to one of the ethers d) known under the INCI name Hydroxypropyl Methylcellulose and commercially obtainable from various suppliers under the names Tegocel® or Methocel® for example.

The non-ionic cellulose ether(s) d) is (are) preferably used in the cleaning agents according to the invention in amounts from 0.01 to 5 wt. %, more preferably from 0.025 to 4 wt. %, particularly preferably from 0.05 to 3 wt. % and in particular from 0.1 to 2 wt. %, the stated amounts relating to the total weight of the cleaning agent.

In a first preferred embodiment cosmetic cleaning agents according to the invention contain—relative to their total weight—
a) 0.5 to 15 wt. % of at least one alkyl sulfate salt and/or alkyl polyglycol ether sulfate salt of formula R—O(CH₂—CH₂O)ₓ—OSO₃⁻X⁺, in which R denotes a linear or branched, saturated or unsaturated alkyl group having 8 to 30 C atoms, x denotes 0 or a number from 1 to 12 and X denotes an alkali, alkaline-earth, ammonium or alkanolamine ion,
b) 0.5 to 15 wt. % of at least one amphoteric and/or zwitterionic surfactant according to one of the aforementioned formulae (I) or (II), in which the residue R mostly denotes a straight-chain or branched, saturated or mono- or polyunsaturated alkyl residue having 8 to 20, more preferably 8 to 16 and in particular 8 to 12 C atoms, and n denotes the numbers 1, 2 or 3,
c) 0.01 to 5 wt. % of at least one sorbitan acid ester, the carboxylic acid component of which derives from a straight-chain or branched, saturated or unsaturated carboxylic acid having 4 to 16, preferably 5 to 12 and in particular 6 to 10 carbon atoms in the molecule, and
d) 0.01 to 5 wt. % of at least one non-ionic cellulose ether selected from carboxymethylcellulose, methylcellulose, ethylcellulose, propylcellulose, hydroxymethyl cellulose, hydroxyethyl cellulose, hydroxypropyl cellulose, hydroxybutyl cellulose, hydroxyethyl methylcellulose, hydroxyethyl ethylcellulose, hydroxypropyl methylcellulose and/or hydroxybutyl methylcellulose,
with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

Within this embodiment it is more preferable if cleaning agents according to the invention contain—relative to their total weight—
a) 1 to 10 wt. % of at least one alkyl ether sulfate having an alkyl residue with 8 to 18 and in particular 10 to 16 C atoms and 1 to 6 and in particular 2 to 4 ethylene oxide units,
b) 1 to 10 wt. % of at least one of the amphoteric or zwitterionic surfactants known under the INCI names Coco Betaine, Lauryl Betaine, Myristyl Betaine, Lauramidopropyl Betaine and/or Cocamidopropyl Betaine,
c) 0.05 to 3 wt. % of at least one sorbitan hexanoate, sorbitan heptanoate, sorbitan octanoate, sorbitan nonanoate and/or sorbitan decanoate having a hydroxyl value in each case of over 350, and
d) 0.05 to 3 wt. % of at least one non-ionic cellulose ether selected from hydroxyethyl methylcellulose, hydroxyethyl ethylcellulose and/or hydroxypropyl methylcellulose,
with the proviso that the weight ratio of the alkyl ether sulfate(s) a) to the amphoteric or zwitterionic surfactant(s) b) is in the range from 1:0.70 to 1:1.25.

Within this embodiment it is particularly preferable if cleaning agents according to the invention contain—relative to their total weight—
a) 3 to 8.5 wt. % of at least one sodium, magnesium and/or triethanolamine lauryl sulfate salt with an average degree of ethoxylation of 2 to 4,
b) 3 to 8 wt. % of at least one of the amphoteric surfactants known under the INCI name Cocamidopropyl Betaine,
c) 0.1 to 2 wt. % of at least one of the sorbitan acid esters known under the INCI name Sorbitan Sesquicaprylate with a hydroxyl value of over 450, and
d) 0.1 to 2 wt. % of at least one of the non-ionic cellulose ethers known under the INCI name Hydroxypropyl Methylcellulose,
with the proviso that the weight ratio of the lauryl ether sulfate salt(s) a) to the Cocamidopropyl Betaine is in the range from 1:0.75 to 1:1.

As has already been stated, it is preferable in a further embodiment for the cleaning agents according to the invention to contain moreover at least one skin-conditioning component.

The conditioning component(s) can preferably be selected from natural, synthetic and/or mineral oil components, moisturizing and emollient components and cationic polymers.

For particularly gentle cleaning agents it can be preferable to use a combination of at least two of the aforementioned conditioning components, wherein it is more preferable if the at least two conditioning components derive from two different groups of the aforementioned groups of conditioning components.

Triglycerides and mixtures of triglycerides are conventionally used as natural (vegetable) oils. Preferred natural oils are coconut oil, (sweet) almond oil, walnut oil, peach kernel oil, apricot kernel oil, avocado oil, tea tree oil, soybean oil, sesame oil, sunflower oil, tsubaki oil, evening primrose oil, rice bran oil, palm kernel oil, mango kernel oil, lady's smock oil, thistle oil, macadamia nut oil, grape seed oil, amaranth seed oil, argan oil, bamboo oil, olive oil, wheatgerm oil, pumpkin seed oil, mallow oil, hazelnut oil, safflower oil, canola oil, sasanqua oil, jojoba oil, rambutan oil, cocoa butter and shea butter.

Suitable mineral oils are in particular mineral oils, paraffin and isoparaffin oils and synthetic hydrocarbons. One example of a suitable hydrocarbon is the commercially available 1,3-di-(2-ethylhexyl)cyclohexane (Cetiol® S), for example.

Dialkyl ethers, for example di-n-octyl ethers, fatty acids, fatty alcohols and natural and synthetic waxes, which can be present both in solid form and also in liquid form in aqueous dispersion, can be used as synthetic oils.

Examples of suitable fatty acids are hexanoic acid, octanoic acid, 2-ethylhexanoic acid, decanoic acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, eicosanoic acid, gadoleic acid, docosanoic acid and erucic acid and technical mixtures thereof.

The fatty acid cuts obtainable from coconut oil or palm oil are conventionally preferred; as a rule the use of stearic acid is preferred in particular.

Suitable fatty alcohols are for example decanol, octanol, octenol, dodecenol, decenol, octadienol, dodecadienol, decadienol, oleyl alcohol, erucic alcohol, ricinol alcohol, stearyl alcohol, isostearyl alcohol, cetyl alcohol, lauryl alcohol, myristyl alcohol, arachidyl alcohol, capryl alcohol, capric alcohol, linoleyl alcohol, linolenyl alcohol and behenyl alcohol, as well as the Guerbet alcohols thereof.

Solid paraffins or isoparaffins, carnauba waxes, beeswaxes, candelilla waxes, ozokerites, ceresin, spermaceti wax, sunflower wax, fruit waxes such as for example apple wax or citrus wax, PE or PP microwaxes can be used as natural or synthetic waxes.

Further suitable solids are, for example
ester oils. Ester oils are understood to be the esters of C₆-C₃₀ fatty acids with C₂-C₃₀ fatty alcohols. Isopropyl myristate (Rilanit® IPM), isononanoic acid C₁₆₋₁₈ alkyl ester (Cetiol® SN), 2-ethylhexyl palmitate (Cegesoft®24), stearic acid 2-ethylhexyl ester (Cetiol®868), cetyl oleate, glycerol tricaprylate, coconut fatty alcohol caprinate/caprylate (Cetiol® LC), n-butyl stearate, oleyl erucate (Cetiol®600), isopropyl palmitate (Rilanit® IPP), oleyl oleate (Cetiol®), lauric acid hexyl ester (Cetiol® A), di-n-butyl adipate (Cetiol® B), myristyl myristate (Cetiol® MM), cetearyl isononanoate (Cetiol® SN), oleic acid decyl ester (Cetiol® V) are preferred, for example,
dicarboxylic acid esters such as di-n-butyl adipate, di-(2-ethylhexyl)adipate, di-(2-ethylhexyl)succinate and diisotridecyl acelate and also diol esters such as ethylene glycol dioleate, ethylene glycol diisotridecanoate, propylene glycol di-(2-ethyl hexanoate), propylene glycol diisostearate, propylene glycol dipelargonate, butanediol diisostearate, neopentyl glycol dicaprylate,
symmetrical, asymmetrical or cyclic esters of carbonic acid with fatty alcohols,
glycerol carbonate or dicaprylyl carbonate (Cetiol® CC), ethoxylated or non-ethoxylated mono-, di- and tri-fatty acid esters of saturated and/or unsaturated linear and/or branched fatty acids with glycerol, such as for example Monomuls®90-018, Monomuls®90-L12, Cetiol® HE or Cutina® MD.

Particularly preferred oil components for use in the cleaning agents according to the invention are selected from aforementioned natural oils, ester oils and/or ethoxylated or non-ethoxylated mono-, di- and tri-fatty acid esters of saturated and/or unsaturated linear and/or branched fatty acids with glycerol.

The aforementioned oil components preferably also serve as emollients for the skin.

Cleaning agents according to the invention that are preferred in particular contain at least one skin-conditioning component selected from at least one natural oil and/or 2 to 30 times, preferably 3 to 20 times and in particular 5 to 10 times ethoxylated mono-, di- and/or tri-fatty acid esters of saturated and/or unsaturated linear and/or branched C₈-C₂₄ fatty acids, preferably C₁₀-C₁₈ fatty acids with glycerol (for example the components known under the INCI names PEG-10 Olive Glyceride, PEG-9 Cocoglyceride, Glycereth-5 Cocoate, PEG-7 Glyceryl Cocoate, PEG-6 Caprylic/Capric Glyceride). PEG-7 Glyceryl Cocoate is most particularly preferred.

The aforementioned, preferred oil components—in particular the (optionally ethoxylated) mono-, di- and/or triesters of glycerol with at least one C₈-C₂₄ fatty acid—can preferably be used in the cleaning agents according to the invention in amounts from 0.01 to 5 wt. %, more preferably from 0.025 to 4 wt. %, particularly preferably from 0.05 to 3 wt. % and in particular from 0.1 to 2 wt. %, the stated amounts relating to the total weight of the cleaning agents.

Suitable moisturizing components are understood to be cosmetically suitable active ingredients which counteract the drying out of the stratum corneum of the epidermis during cleaning and which can therefore contribute to the increased softness and elasticity of the skin.

Examples of suitable moisturizing components are collagen preparations, ethoxylated glycose derivatives, glycerol, sorbitol and/or hyaluronic acid.

Suitable moisturizing components can be added to the cleaning agents according to the invention—relative to their total weight—in amounts preferably from 0.001 to 15 wt. %, particularly preferably from 0.005 to 7.5 and in particular from 0.01 to 5 wt. %.

Suitable cationic polymers are for example:
quaternized cellulose derivatives such as are available commercially under the names Celquat® and Polymer JR®,
hydrophobically modified cellulose derivatives, for example the cationic polymers sold under the trade name SoftCat®,
cationic alkyl polyglycosides,
cationized honey, for example the commercial product Honeyquat®50,
cationic guar derivatives, such as in particular the products sold under the trade names Cosmedia® Guar N-Hance® and Jaguar®,
polymeric dimethyl diallyl ammonium salts and copolymers thereof with esters and amides of acrylic acid and methacrylic acid. The products available commercially under the names Merquat 100 (poly(dimethyl diallyl ammonium chloride)) and Merquat®550 (dimethyl diallyl ammonium chloride acrylamide copolymer) are examples of such cationic polymers,
copolymers of vinyl pyrrolidone with quaternized derivatives of diallyl aminoalkyl acrylate and methacrylate, such as for example diethyl sulfate-quaternized vinyl pyrrolidone-dimethyl aminoethyl methacrylate copolymers. Such compounds are commercially available under the names Gafquat®734 and Gafquat®755, vinyl pyrrolidone-vinyl imidazolium methochloride copolymers, such as are sold under the names Luviquat® FC 370, FC 550, FC 905 and HM 552, quaternized polyvinyl alcohol,
   as well as the polymers known under the names
Polyquaternium 2, Polyquaternium 17, Polyquaternium 18, Polyquaternium-24, Polyquaternium 27, Polyquaternium-32, Polyquaternium-37, Polyquaternium 74 and Polyquaternium 89.

Preferred cationic polymers are quaternized cellulose polymers, cationic guar derivatives and/or cationic polymers based on acrylic acid (derivatives), which are particularly preferably selected from the polymers known under the INCI names Guar Hydroxypropyltrimonium Chloride, Polyquaternium-6, Polyquaternium-7, Polyquaternium-10, Polyquaternium-37 and/or Polyquaternium-67.

A cationic polymer known under the INCI name Polyquaternium-7 is preferred in particular for use in the cleaning agents according to the invention.

The cationic polymer(s) can be used in the cleaning agents according to the invention (relative to their total weight) in an amount preferably from 0.01 to 5 wt. %, more preferably from 0.025 to 4 wt. %, particularly preferably from 0.05 to 3 wt. % and in particular from 0.1 to 2 wt. %.

In a second preferred embodiment cosmetic cleaning agents according to the invention contain—relative to their total weight—

a) 0.5 to 15 wt. % of at least one alkyl sulfate salt and/or alkyl polyglycol ether sulfate salt of formula R—O(CH₂—CH₂O)ₓ—OSO₃⁻X⁺, in which R denotes a linear or branched, saturated or unsaturated alkyl group having 8 to 30 C atoms, x denotes 0 or a number from 1 to 12 and X denotes an alkali, alkaline-earth, ammonium or alkanolamine ion,
b) 0.5 to 15 wt. % of at least one amphoteric and/or zwitterionic surfactant according to one of the aforementioned formulae (I) or (II), in which the residue R mostly denotes a straight-chain or branched, saturated or mono- or polyunsaturated alkyl residue having 8 to 20, more preferably 8 to 16 and in particular 8 to 12 C atoms, and n denotes the numbers 1, 2 or 3,
c) 0.01 to 5 wt. % of at least one sorbitan acid ester, the carboxylic acid component of which derives from a straight-chain or branched, saturated or unsaturated carboxylic acid having 4 to 16, preferably 5 to 12 and in particular 6 to 10 carbon atoms in the molecule,
d) 0.01 to 5 wt. % of at least one non-ionic cellulose ether selected from carboxymethylcellulose, methylcellulose, ethylcellulose, propylcellulose, hydroxymethyl cellulose, hydroxyethyl cellulose, hydroxypropyl cellulose, hydroxybutyl cellulose, hydroxyethyl methylcellulose, hydroxyethyl ethylcellulose, hydroxypropyl methylcellulose and/or hydroxybutyl methylcellulose, and
e) 0.01 to 5 wt. % of at least one oil component selected from natural oils, ester oils and/or ethoxylated or non-ethoxylated mono-, di- and tri-fatty acid esters of saturated and/or unsaturated linear and/or branched fatty acids with glycerol,
with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

Within this embodiment it is more preferable if cleaning agents according to the invention contain—relative to their total weight—
a) 1 to 10 wt. % of at least one alkyl ether sulfate having an alkyl residue with 8 to 18 and in particular 10 to 16 C atoms and 1 to 6 and in particular 2 to 4 ethylene oxide units,
b) 1 to 10 wt. % of at least one of the amphoteric or zwitterionic surfactants known under the INCI names Coco Betaine, Lauryl Betaine, Myristyl Betaine, Lauramidopropyl Betaine and/or Cocamidopropyl Betaine,
c) 0.05 to 3 wt. % of at least one sorbitan hexanoate, sorbitan heptanoate, sorbitan octanoate, sorbitan nonanoate and/or sorbitan decanoate having a hydroxyl value in each case of over 350,
d) 0.05 to 3 wt. % of at least one non-ionic cellulose ether selected from hydroxyethyl methylcellulose, hydroxyethyl ethylcellulose and/or hydroxypropyl methylcellulose, and
e) 0.05 to 3 wt. % of at least one natural oil and/or of a 2 to 30 times, preferably 3 to 20 times and in particular 5 to 10 times ethoxylated mono-, di- and/or tri-fatty acid ester of a saturated and/or unsaturated, linear and/or branched C₈-C₂₄ fatty acid, preferably a C₁₀-C₁₈ fatty acid, with glycerol,
with the proviso that the weight ratio of the alkyl ether sulfate(s) a) to the amphoteric or zwitterionic surfactant(s) b) is in the range from 1:0.70 to 1:1.25.

Within this embodiment it is particularly preferable if cleaning agents according to the invention contain—relative to their total weight—
a) 3 to 8.5 wt. % of at least one sodium, magnesium and/or triethanolamine lauryl sulfate salt with an average degree of ethoxylation of 2 to 4,
b) 3 to 8 wt. % of at least one of the amphoteric surfactants known under the INCI name Cocamidopropyl Betaine,
c) 0.1 to 2 wt. % of at least one of the sorbitan acid esters known under the INCI name Sorbitan Sesquicaprylate with a hydroxyl value of over 450,
d) 0.1 to 2 wt. % of at least one of the non-ionic cellulose ethers known under the INCI name Hydroxypropyl Methylcellulose, and
e) 0.1 to 2 wt. % of at least one natural oil and/or of one of the oil components known under the INCI name PEG-7 Glyceryl Cocoate (or of an emollient),
with the proviso that the weight ratio of the lauryl ether sulfate salt(s) a) to the Cocamidopropyl Betaine is in the range from 1:0.75 to 1:1.

In a third preferred embodiment cosmetic cleaning agents according to the invention contain—relative to their total weight—
a) 0.5 to 15 wt. % of at least one alkyl sulfate salt and/or alkyl polyglycol ether sulfate salt of formula R—O(CH₂—CH₂O)ₓ—OSO₃⁻X⁺, in which R denotes a linear or branched, saturated or unsaturated alkyl group having 8 to 30 C atoms, x denotes 0 or a number from 1 to 12 and X denotes an alkali, alkaline-earth, ammonium or alkanolamine ion,
b) 0.5 to 15 wt. % of at least one amphoteric and/or zwitterionic surfactant according to one of the aforementioned formulae (I) or (II), in which the residue R mostly denotes a straight-chain or branched, saturated or mono- or polyunsaturated alkyl residue having 8 to 20, more preferably 8 to 16 and in particular 8 to 12 C atoms, and n denotes the numbers 1, 2 or 3,
c) 0.01 to 5 wt. % of at least one sorbitan acid ester, the carboxylic acid component of which derives from a straight-chain or branched, saturated or unsaturated carboxylic acid having 4 to 16, preferably 5 to 12 and in particular 6 to 10 carbon atoms in the molecule,
d) 0.01 to 5 wt. % of at least one non-ionic cellulose ether selected from carboxymethylcellulose, methylcellulose, ethylcellulose, propylcellulose, hydroxymethyl cellulose, hydroxyethyl cellulose, hydroxypropyl cellulose, hydroxybutyl cellulose, hydroxyethyl methylcellulose, hydroxyethyl ethylcellulose, hydroxypropyl methylcellulose and/or hydroxybutyl methylcellulose,
e) 0.01 to 5 wt. % of at least one oil component selected from natural oils, ester oils and/or ethoxylated or non-ethoxylated mono-, di- and tri-fatty acid esters of saturated and/or unsaturated linear and/or branched fatty acids with glycerol, and
f) 0.01 to 5 wt. % of at least one cationic polymer,
with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

Within this embodiment it is more preferable if cleaning agents according to the invention contain—relative to their total weight—
a) 1 to 10 wt. % of at least one alkyl ether sulfate having an alkyl residue with 8 to 18 and in particular 10 to 16 C atoms and 1 to 6 and in particular 2 to 4 ethylene oxide units,
b) 1 to 10 wt. % of at least one of the amphoteric or zwitterionic surfactants known under the INCI names Coco Betaine, Lauryl Betaine, Myristyl Betaine, Lauramidopropyl Betaine and/or Cocamidopropyl Betaine,
c) 0.05 to 3 wt. % of at least one sorbitan hexanoate, sorbitan heptanoate, sorbitan octanoate, sorbitan nonanoate and/or sorbitan decanoate having a hydroxyl value in each case of over 350,
d) 0.05 to 3 wt. % of at least one non-ionic cellulose ether selected from hydroxyethyl methylcellulose, hydroxyethyl ethylcellulose and/or hydroxypropyl methylcellulose,
e) 0.05 to 3 wt. % of at least one natural oil and/or of a 2 to 30 times, preferably 3 to 20 times and in particular 5 to 10 times ethoxylated mono-, di- and/or tri-fatty acid ester of a saturated and/or unsaturated, linear and/or branched C₈-C₂₄ fatty acid, preferably a C₁₀-C₁₈ fatty acid, with glycerol, and
f) 0.05 to 3 wt. % of at least one of the cationic polymers known under the INCI names Guar Hydroxypropyltrimonium Chloride, Polyquaternium-6, Polyquaternium-7, Polyquatemium-10, Polyquatemium-37 and/or Polyquaternium-67,
with the proviso that the weight ratio of the alkyl ether sulfate(s) a) to the amphoteric or zwitterionic surfactant(s) b) is in the range from 1:0.70 to 1:1.25.

Within this embodiment it is particularly preferable if cleaning agents according to the invention contain—relative to their total weight—
a) 3 to 8.5 wt. % of at least one sodium, magnesium and/or triethanolamine lauryl sulfate salt with an average degree of ethoxylation of 2 to 4,
b) 3 to 8 wt. % of at least one of the amphoteric surfactants known under the INCI name Cocamidopropyl Betaine,
c) 0.1 to 2 wt. % of at least one of the sorbitan acid esters known under the INCI name Sorbitan Sesquicaprylate with a hydroxyl value of over 450,
d) 0.1 to 2 wt. % of at least one of the non-ionic cellulose ethers known under the INCI name Hydroxypropyl Methylcellulose,
e) 0.1 to 2 wt. % of at least one natural oil and/or of one of the oil components known under the INCI name PEG-7 Glyceryl Cocoate (or of an emollient), and
f) 0.1 to 2 wt. % of at least one of the cationic polymers known under the INCI name Polyquaternium-7,
with the proviso that the weight ratio of the lauryl ether sulfate salt(s) a) to the Cocamidopropyl Betaine is in the range from 1:0.75 to 1:1.

For some application forms of the cleaning agents according to the invention it can be advantageous for them to have a particularly rich, creamy texture.

To achieve this objective it is advantageous for the cleaning agents according to the invention to contain associative thickeners for the purpose of viscosity adjustment.

The associative thickener(s) can optionally be combined with further thickening agents described below.

For example, suitable associative thickeners can be (but do not have to be exclusively) selected from ethoxylated propylene glycol mono- and/or diesters and/or glycerol mono- and/or diesters, the carboxylic acid component in the esters preferably having a chain length from 2 to 24.

Aforementioned esters having a degree of ethoxylation of at least 10, more preferably at least 12 and in particular at least 15 are preferably used as associative thickeners in the cleaning agents according to the invention.

Examples of particularly suitable associative thickeners are known under the INCI names PEG-18 Glyceryl Oleate/Cocoate, PEG-55 Propylene Glycol Oleate, PEG-150 Distearate and/or PEG-200 Hydrogenated Glyceryl Palmate and are commercially available under the names Antil® or Atlas®.

The associative thickeners can be used in the cleaning agents according to the invention—relative to their total weight—in amounts preferably from 0.01 to 10 wt. %, more preferably from 0.05 to 7.5 wt. %, particularly preferably from 0.075 to 5 wt. % and in particular from 0.1 to 4 wt. %.

The cleaning agents according to the invention can contain further thickening agents, which can be selected for example from polymeric thickening agents.

Suitable polymeric thickening agents are understood to be, for example, acrylate-based polymers, some of which can have relatively high molar masses in the region of >1,000,000 g/mol.

Suitable products are for example the polymers and/or copolymers sold by Rohm & Haas under the name Acusol®, which are predominantly polyacrylates with differing alkylation or crosslinking or hydrophobically modified non-ionic polyols, or the products sold by B.F. Goodrich under the name Carbopol®, which are polyacrylates or copolymers of acrylic acid and alkylated (preferably C5- to C10-alkylated) acrylic acids, or the products sold by B.F. Goodrich under the name Pemulen®, which are high-molecular-weight acrylic acid copolymers of the acrylate/C10 to C30 alkyl acrylate crosspolymer type.

Further thickening agents that are suitable for the cleaning agents according to the invention can be selected from micellar thickening agents.

Micellar thickening agents are understood to be preferably C₈-C₂₄ carboxylic acid (C₁-C₄) alkanolamides, ethoxylated C₈-C₂₄ fatty alcohols and/or electrolytes, the compounds known under the INCI names Cocamide MEA, Cocamide DEA, Cocamide MIPA, Laureth-2 and/or Laureth-4 and also NaCl and Na₂SO₄ being particularly preferred.

The polymeric and/or micellar thickening agents can be used in the cleaning agents according to the invention—relative to their total weight—in amounts preferably from 0.01 to 10 wt. %, more preferably from 0.05 to 7.5 wt. %, particularly preferably from 0.075 to 5 wt. % and in particular from 0.1 to 4 wt. %.

In addition to the aforementioned active ingredients, the cleaning agents according to the invention can also contain a series of further active ingredients which impart advantageous properties thereto.

The preferred optional active ingredients that can be used in the cleaning agents according to the invention include for example non-ionic surfactants and/or non-ionic emulsifiers along with further anionic surfactants that differ from a).

The non-ionic surfactants and/or non-ionic emulsifiers along with the further anionic surfactants that differ from a) can be used in the cleaning agents according to the invention (relative to their total weight) in an amount preferably from 0.1 to 7.5 wt. %, particularly preferably from 0.25 to 5 wt. % and in particular from 0.5 to 3 wt. %.

The suitable non-ionic surfactants/emulsifiers include for example amine oxides,
addition products of 2 to 50 mol of ethylene oxide and/or 0 to 5 mol of propylene oxide with linear and branched fatty alcohols having 8 to 30 C atoms, with fatty acids having 8 to 30 C atoms and with alkyl phenols having 8 to 15 C atoms in the alkyl group,
addition products of 5 to 60 mol of ethylene oxide with castor oil and/or hydrogenated castor oil,
sugar fatty acid esters and addition products of ethylene oxide with sugar fatty acid esters,
fatty acid alkanolamides,
addition products of ethylene oxide with fatty amines, and/or
alkyl polyglucosides.

Particularly suitable non-ionic surfactants/emulsifiers are alkyl oligoglucosides, in particular alkyl oligoglucosides based on hydrogenated C_{12/14} coconut alcohol with a DP of 1 to 3, such as are available commercially for example under the INCI name Coco-Glucoside.

Further preferred non-ionic surfactants/emulsifiers are addition products of 5 to 60 mol of ethylene oxide with castor oil and/or hydrogenated castor oil, such as for example the emulsifiers known under the INCI names PEG-40 Hydrogenated Castor Oil and/or PEG-60 Hydrogenated Castor Oil.

The suitable further anionic surfactants that differ from a) include for example:
linear and branched fatty acids having 8 to 30 C atoms (soaps),
ether carboxylic acids of the formula R—O—(CH₂—CH₂O)ₓ—CH₂—COOH, in which R is a linear or branched, saturated or unsaturated alkyl group having 8 to 30 C atoms and x=0 or 1 to 16,
acyl sarcosides having 8 to 24 C atoms in the acyl group,
acyl taurides having 8 to 24 C atoms in the acyl group,
acyl glutamates having 8 to 24 C atoms in the acyl group,
acyl isethionates having 8 to 24 C atoms in the acyl group,
sulfosuccinic acid mono- and/or dialkyl esters having 8 to 24 C atoms in the alkyl group and sulfosuccinic acid monoalkyl polyoxyethyl esters having 8 to 24 C atoms in the alkyl group and 1 to 6 oxyethyl groups, and/or
alpha-olefin sulfonates having 8 to 24 C atoms.

The further optional components that can be used in the cleaning agents according to the invention include for example
vitamins, vitamin derivatives and/or vitamin precursors,
plant extracts,
pearlescent agents and/or
opacifiers.

Suitable vitamins are understood to be preferably the following vitamins, provitamins and vitamin precursors as well as derivatives thereof:
Vitamin A: the group of substances classed as vitamin A includes retinol (vitamin A₁) and 3,4-didehydroretinol (vitamin A₂). β-Carotene is the retinol provitamin. Suitable vitamin A components are for example vitamin A acid and esters thereof, vitamin A aldehyde and vitamin A alcohol and esters thereof such as the palmitate and acetate. Vitamin B: the vitamin B group or vitamin B complex includes inter alia
   Vitamin B₁ (thiamine)
   Vitamin B₂ (riboflavin)
   Vitamin B₃. The compounds nicotinic acid and nicotinic acid amide (niacinamide) are often included under this term.
   Vitamin B₅ (pantothenic acid and panthenol). Within the context of this group panthenol is preferably used. Derivatives of panthenol which can be used are in particular the esters and ethers of panthenol as well as cationically derivatized panthenols. Individual representatives are for example panthenol triacetate, panthenol monoethyl ether and the monoacetate thereof, and cationic panthenol derivatives.
   Vitamin B₆ (pyridoxine as well as pyridoxamine and pyridoxal).
Vitamin C (ascorbic acid): use in the form of the palmitic acid ester, glucosides or phosphates can be preferred. Use in combination with tocopherols can likewise be preferred.
Vitamin E (tocopherols, in particular α-tocopherol).
Vitamin F: the term “vitamin F” is conventionally understood to mean essential fatty acids, in particular linoleic acid, linolenic acid and arachidonic acid.
Vitamin H: vitamin H is the name given to the compound (3aS,4S, 6aR)-2-oxohexahydrothienol[3,4-d]-imidazole-4-valeric acid, although this is now more widely known by the trivial name biotin.

The cleaning agents according to the invention can preferably contain vitamins, provitamins and vitamin precursors from groups A, B, E and H.

Nicotinic acid amide, biotin, pantolactone and/or panthenol are preferred in particular.

Vitamins, vitamin derivatives and/or vitamin precursors can be used in the cleaning agents (relative to their total weight) in an amount preferably from 0.001 to 2 wt. %, particularly preferably from 0.005 to 1 wt. % and in particular from 0.01 to 0.5 wt. %.

Suitable plant extracts are understood to be extracts which can be produced from all parts of a plant.

These extracts are conventionally produced by extraction of the entire plant. It can also be preferable in individual cases, however, to produce the extracts exclusively from flowers and/or leaves of the plant.

The extracts from green tea, oak bark, stinging nettle, witch hazel, hops, chamomile, burdock, horsetail, whitethorn, lime blossom, lychee, almond, aloe vera, pine, horse chestnut, sandalwood, juniper, coconut, mango, apricot, lemon, wheat, kiwi, melon, orange, grapefruit, sage, rosemary, birch, mallow, lady's smock, wild thyme, yarrow, thyme, melissa, restharrow, coltsfoot, marshmallow, ginseng, ginger root, Echinacea purpurea, Olea europaea, Boerhavia diffusa root, Foeniculum vulgaris and Apium graveolens are suitable above all.

The extracts of green tea, stinging nettle, witch hazel, chamomile, aloe vera, ginseng, Echinacea purpurea, Olea europaea and/or Boerhavia diffusa root are particularly preferred for use in the cleaning agents according to the invention.

Water, alcohols and mixtures thereof can be used as extracting agents to produce the cited plant extracts. Of the alcohols, low alcohols such as ethanol and isopropanol, but in particular polyhydric alcohols such as ethylene glycol and propylene glycol, are preferred, both as the sole extracting agent and mixed with water. Plant extracts based on water/propylene glycol in the ratio 1:10 to 10:1 have proved to be particularly suitable.

The plant extracts can be used in both pure and diluted form. If they are used in diluted form they conventionally contain approximately 2 to 80 wt % of active substance and as the solvent the extracting agent or mixture of extracting agents used to obtain them.

The plant extracts can be used in the agents according to the invention (relative to their total weight) in an amount preferably from 0.01 to 10 wt. %, more preferably from 0.05 to 7.5 wt. % and in particular from 0.1 to 5 wt. %.

The cleaning agents according to the invention can moreover contain—relative to their total weight—preferably 0.001 to 5 wt. %, more preferably 0.005 to 4 wt. %, particularly preferably 0.01 to 3 wt. % and in particular 0.05 to 2 wt. % of at least one opacifier and/or pearlescent agent.

Suitable pearlescent agents and opacifiers are understood to be, for example
mono- and/or diesters of ethylene glycol, 1,2-propanediol and/or glycerol with C₈-C₂₄ fatty acids,
esters of polyethylene glycols with C₈-C₂₄ fatty acids, and/or
styrene/acrylate copolymers.

The opacifiers and/or pearlescent agents known under the following INCI names are particularly suitable:
Glycol Distearate, such as for example the commercial product Cutina® AGS from Cognis, Glycol Monostearate, such as for example the commercial product Cutina® EGMS from Cognis, PEG-3 Distearate, such as for example the commercial product Genapol® TS from Clariant, PEG-2 Distearate, such as for example the commercial product Kessco® DEGMS from Akzo Nobel, Propylene Glycol Stearate, such as for example the commercial product Tegin® P from Goldschmidt and/or Styrene/Acrylates Copolymers such as for example the commercial products Joncryl®67 from Johnson Polymers, Suprawal® WS from BASF and/or Acusol® OP 301 from Rohm & Haas.

The opacifiers and/or pearlescent agents known under the following INCI names are suitable in particular for use in the cleaning agents according to the invention: Glycol Distearate, Glycol Monostearate, PEG-3 Distearate and/or Styrene/Acrylates Copolymer.

Further active ingredients, auxiliary substances and additives that can be used in the cleaning agents according to the invention are for example:
UV filters,
texturizing agents such as maleic acid and lactic acid, dyes to color the agent,
substances to adjust the pH, for example α- and β-hydroxycarboxylic acids such as citric acid, lactic acid, malic acid, glycolic acid, and NaOH,
skin-calming active ingredients such as allantoin and/or bisabolol,
complexing agents such as EDTA, NTA, β-alanine diacetic acid and phosphonic acids,
ceramides. Ceramides are understood to be N-acyl sphingosine (fatty acid amides of sphingosine) or synthetic analogs of such lipids (known as pseudoceramides),
propellants such as propane-butane mixtures, N₂O, dimethyl ether, CO₂ and air, antioxidants.
perfumes,
preservatives, such as for example benzoic acid and/or salicylic acid or physiologically acceptable salts thereof.

The cleaning agents according to the invention preferably have a pH in a skin-friendly range from 4 to 7, preferably from 4 to 6 and in particular from 4.5 to 5.5.

Cosmetic cleaning agents that are preferred according to the invention preferably have a viscosity in the range from 5000 to 18,000 mPas, preferably from 6000 to 13,000 mPas and in particular from 7500 to 11,000 mPas (measured in each case using a Haake rotary viscometer VT550; 20° C.; measuring device MV; spindle MV II; 8 rpm).

Compositions with this viscosity can be conveniently and easily applied from a container onto the hand or application surface without running through the fingers and dripping. At the same time the viscosity of the composition is low enough to ensure that it can be satisfactorily distributed over the application surface using the hands.

The cleaning agents according to the invention exhibit outstanding properties when applied to the skin.

They offer particularly good skin compatibility and yield a particularly stable, creamy foam, which develops quickly and can be readily distributed over the skin. After rinsing, the foam leaves the skin feeling pleasantly relaxed.

The texture of the cleaning agents according to the invention is particularly rich.

A further advantage of the cleaning agents according to the invention lies in the fact that they can be formulated with a total surfactant content starting at just 14 wt. %, without any application-related disadvantages (in terms of amount of foam, foam development, foam properties, cleaning and conditioning). Therefore the production of particularly sensitive compositions is possible.

### EXAMPLES

The table below contains examples of cleaning compositions according to the invention (shower gel compositions).

Unless otherwise specified, the stated amounts in the table relate to percentages by weight.

| | 1 | 2 | 3 | 4 |
|---|---|---|---|---|
| Sodium laureth sulfate (2EO, 70%) | 10 | 11 | 10.5 | 10.5 |
| Cocamidopropyl betaine (40%) | 16.1 | 16.5 | 16.5 | 16.5 |
| Antil Soft ®¹ SC | 0.20 | 0.40 | 0.2 | 0.40 |
| Tegocel ®² HPM 50 | 0.20 | 0.20 | 0.1 | 0.20 |
| Sodium benzoate | 0.4 | 0.5 | 0.5 | 0.5 |
| Polyquaternium-7 (clear solution; | 2 | 1.5 | 1.5 | 1.5 |
| AS approx. 9%) | | | | |
| Almond oil, sweet | 0.10 | — | 0.1 | — |
| Olive oil | — | 0.2 | — | 0.1 |
| Cetiof ®³ HE | 0.5 | 0.75 | 0.5 | 0.5 |
| PEG-40 hydrogenated castor oil | 0.4 | 0.75 | 0.5 | 0.6 |
| Antil ®⁴ 141 | 1 | 1.5 | 1.2 | 1.2 |
| Acusol ®⁵ OP 301 | — | — | 1 | — |
| Euperlan ®⁶ PK 3000 | — | — | — | 2 |
| Perfume | 1 | 1 | 1 | — |
| Citric acid | 0.35 | 0.35 | — | 2 |
| Water | to 100 | to 100 | to 100 | to 100 |

The following commercial products were used:
¹INCI name: Sorbitan Sesquicaprylate; Evonik Goldschmidt,
²INCI name: Hydroxypropyl Methylcellulose; Evonik,
³INCI name: PEG-7 Glyceryl Cocoate; Cognis,
⁴INCI name: Propylene Glycol, PEG-55 Propylene Glycol Oleate; Goldschmidt,
⁵INCI name: Styrene/Acrylates Copolymer; Rohm & Haas,
⁶INCI name: Glycol Distearate, Cocamidopropyl Betaine, Laureth-4; Cognis

The following commercial products were used:
1 INCI name: Sorbitan Sesquicaprylate; Evonik Goldschmidt,
2 INCI name: Hydroxypropyl Methylcellulose; Evonik,
3 INCI name: PEG-7 Glyceryl Cocoate; Cognis,
4 INCI name: Propylene Glycol, PEG-55 Propylene Glycol Oleate; Goldschmidt,
5 INCI name: Styrene/Acrylates Copolymer; Rohm & Haas,
6 INCI name: Glycol Distearate, Cocamidopropyl Betaine, Laureth-4; Cognis

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cosmetic cleaning agent, containing in a suitable carrier
a) at least one alkyl sulfate salt and/or alkyl polyglycol ether sulfate salt,
b) at least one amphoteric and/or zwitterionic surfactant according to one of the general formulae (I) or (II) 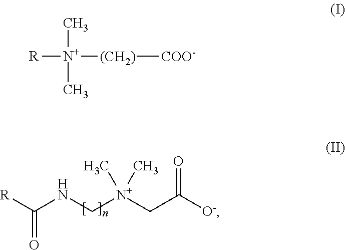
in which the residue R in each case denotes a straight-chain or branched, saturated or mono- or polyunsaturated alkyl or alkenyl residue having 8 to 24 carbon atoms and n denotes a number from 1 to 6,
c) at least one sorbitan acid ester and
d) at least one non-ionic cellulose ether,
with the proviso that the weight ratio of the alkyl sulfate salt(s) and/or alkyl polyglycol ether sulfate salt(s) a) to the amphoteric or zwitterionic surfactant(s) of formula (I) or (II) is in the range from 1:0.65 to 1:1.5.

2. The cosmetic cleaning agent according to claim 1, characterized in that the weight ratio of the alkyl sulfate salt(s) and/or alkyl polyglycol ether sulfate salt(s) a) to the amphoteric or zwitterionic surfactant(s) of formula (I) or (II) is in the range from 1:0.70 to 1:1.25.

3. The cosmetic cleaning agent according to claim 1, characterized in that it includes, relative to its total weight, 0.01 to 5 wt. % of the sorbitan ester c).

4. The cosmetic cleaning agent according to claim 1, characterized in that the carboxylic acid component of the sorbitan acid ester c) is derived from a straight-chain or branched, saturated or unsaturated carboxylic acid having 6 to 10 carbon atoms.

5. The cosmetic cleaning agent according to claim 1, characterized in that as the sorbitan acid ester c) it contains a sorbitan acid ester known under the INCI name Sorbitan Sesquicaprylate.

6. The cosmetic cleaning agent according to claim 1, characterized in that it includes, relative to its total weight, 0.01 to 5 wt. % of the non-ionic cellulose ether d), which is selected from mixed hydroxyalkyl alkyl celluloses having in each case 1 to 4 carbon atoms in the alkyl chain.

7. The cosmetic cleaning agent according to claim 1, characterized in that as the non-ionic cellulose ether d) it contains a cellulose ether known under the INCI name Hydroxypropyl Methylcellulose.

8. The cosmetic cleaning agent according to claim 1, characterized in that it includes, relative to its total weight, 0.01 to 5 wt. % of at least one optionally ethoxylated mono-, di- and/or triester of glycerol with at least one C₈-C₂₄ fatty acid.

9. The cosmetic cleaning agent according to one of claims 1, characterized in that it includes, relative to its total weight, 0.01 to 5 wt. % of at least one cationic polymer.

10. The cosmetic cleaning agent according to claim 1, characterized in that it includes, relative to its total weight, 0.01 to 10 wt. % of at least one associative thickener.
